(19) United States
(12) Patent Application Publication
(10) Pub. No.: US 2026/0015127 A1
(43) Pub. Date: Jan. 15, 2026

(54) APPARATUS FOR A REUSABLE UNIVERSAL SKID BOARD

(71) Applicant: Quality Research, Development & Consulting, Inc., Wayzata, MN (US)

(72) Inventor: Daryoush Allaei, Wayzata, MN (US)

(21) Appl. No.: 19/269,922

(22) Filed: Jul. 15, 2025

Related U.S. Application Data
(60) Provisional application No. 63/671,455, filed on Jul. 15, 2024.
(60) Provisional application No. 63/741,474, filed on Jan. 3, 2025.

(51) Int. Cl. B65D 19/00; B63B 35/00

(52) U.S. Cl. CPC B65D 19/0002; B63B 35/00; B65D 2519/00034; B65D 2519/00273; B65D 2519/00293; B65D 2519/00308; B65D 2519/00736

(57) ABSTRACT

A reusable skid board may be used to tie down and secure air-drop loads. A reusable skid board may include a rigid polymeric body defining: a flat upper surface; one or more apertures at each side of the rigid polymeric body such that one or more cords are couplable to the one or more of aperture; and a bottom surface coupled to the top surface and defining an internal volume, wherein the rigid polymeric body includes rounded corners and edges and has sufficient buoyancy such that the rigid polymeric body can float without load in seawater.

### CROSS-REFERENCE TO RELATED APPLICATION

This application claims priority to U.S. Provisional Patent Application Ser.

No. 63/671,455, filed on Jul. 15, 2024, and U.S. Provisional Patent Application Ser. No. 63/741,474, filed on Jul. 15, 2024, the contents of each of which are hereby incorporated by reference in entirety.

### BACKGROUND

Reusable universal skid boards can be implemented for supporting items during transport and/or airdrop. The reusable universal skid board can be placed under modules of energy absorbing layers that are placed under shipping items, on the sides of the items, and on top of the items, and can provide a surface for the modules of energy absorbing layers.

### SUMMARY OF THE INVENTION

In an aspect of the invention, a reusable skid board includes a rigid polymeric body defining: a flat upper surface; one or more apertures at each side of the rigid polymeric body such that one or more cords are couplable to the one or more of aperture; and a bottom surface coupled to the top surface and defining an internal volume, wherein the rigid polymeric body includes rounded corners and edges and has sufficient buoyancy such that the rigid polymeric body can float without load in seawater.

The internal volume may contain air. The skid board may include one or more removable plugs, the removal of which allow water to enter the internal volume to modify buoyancy. The removable plugs may be dissolvable in seawater. The internal volume may contain foam.

The one or more apertures may be through-holes extending from the flat upper surface to the bottom surface with a cylindrical wall extending through and sealing the internal volume. The one or more apertures at each side may include two or more apertures at each side, and the skid board may further include one or more grooves on each side, between the two or more apertures on each respective side.

### BRIEF DESCRIPTION OF THE DRAWINGS

FIGS. 1A-1C are illustrative representations of a reusable universal skid board, according to some embodiments.

FIG. 2 is an illustrative representation of a apertures at the side of the reusable universal skid board of FIG. 1, according to some embodiments.

FIG. 3 is an illustrative representation of a reusable universal skid board of FIG. 1 with an assembly of energy absorbing layers placed on top of the reusable universal skid board, according to some embodiments.

FIG. 4A is an illustrative representation of a reusable universal skid board having a groove between a set of apertures, according to some embodiments.

FIG. 4B is an illustrative representation of a reusable universal skid board having a groove between a set of apertures, according to some embodiments.

FIG. 5 is an illustrative representation of a reusable universal skid board having a groove between each set of apertures, according to some embodiments.

### DETAILED DESCRIPTIONS

In some embodiments, reusable universal skid board (also referred to herein as RUSB, “board” or “skid board”) described herein can be a high density plastic or rubber platform that is floatable and capable of securely supporting modules of energy absorbing layers such that the modules can further support items and/or packages for multiple drops and/or airdrops. The reusable universal skid board described herein can be used as a platform for a variety of items, sizes, and/or item types and can be used in drops and/or airdrops in a variety of environments and/or transportation devices. The reusable universal described herein can be comprised of rubber and/or high density polyethylene material and have a weight of 80 pounds at 48 by 48 by 1″, 48 by 48 by 0.75″, 24 by 42 by 1″, or 24 by 42 by 0.75″, as example sizes. The reusable universal skid board can further support a load capacity of 2400 pounds.

In some embodiments, the reusable universal skid board can have curved edges, sides, and/or corners for improved handling. The reusable universal skid board can also have a set of apertures at each edge of the skid board such as, for example, rounded holes, to allow for cordage and/or netting to pass through for securing an item on the skid board. In some cases, a rubber wrap with a Velcro closure can be used to secure and around modules of energy absorbing layers to be further securely placed on the reusable universal skid board. In some cases, the reusable universal skid board can also include rubber handles for improved handling of the reusable universal skid board.

In some embodiments, the energy absorbing layer (also referred to herein as “layer”) for the reusable universal skid board can be an elastomer-based, modular, and adaptable. The energy absorbing layer can be assembled by a packager, which allows for reduced shipping volumes of separate pieces as well as decreased storage volume. The energy absorbing layer can include multiple slits that combine with other energy absorbing layers to make a larger assembly, namely pods.

In some embodiments, the energy absorbing layer can include a board that is generally rectangular in shape and configured for coupling to one another to form a module of energy absorbing layers. For example, each layer can each define a number of slots along a given surface of the layer. The layer can be configured for receiving another layer within a defined slot. In some cases, the layer can be configured to receive a corresponding slot defined by another layer.

The energy absorbing layers described herein can be composed of different compositions. For example, the energy absorbing layers can be composed of an elastomeric material. The elastomeric material can include a polymer such as a polyolefins (e.g., polyethylene, polypropylene, polymethylpentene, polybutene-1, polyisobutylene, ethylene propylene rubber, ethylene propylene diene rubber, and the like), acrylonitrile-butadiene rubber, hydrogenated acrylonitrile-butadiene rubber, fluorocarbon rubber, perfluoroelastomer, silicone rubber, fluorosilicone rubber, chloroprene rubber, neoprene rubber, polyester urethane, polyether urethane, natural rubber, polyacrylate rubber, ethylene acrylic, styrene-butadiene rubber, ethylene oxide epichlorodrine rubber, chlorosulfonated polyethylene, butadiene rubber, isoprene rubber, butyl rubber, and the like. In some cases, plastic or metals can be used as part of the composition. In some cases, the energy absorbing layers can be filled with air pockets (e.g., during the manufacturing process) to further reduce weight, and can improve the ability of the energy absorbing layers to float in water. In some cases, the energy absorbing layers can be filled with pockets of metal, or some other dense material (e.g., during the manufacturing process), which can improve the ability of the energy absorbing layers to sink in water. Additionally, energy absorbing layers can include pockets composed of air, or other fluid. The pockets can modify the buoyancy of the energy absorbing layers. The pockets can impact the performance characteristics of the energy absorbing layers as well. Other materials can be utilized such as cardboard and wood (e.g., dimensional lumber, hardboard, plywood, OSB, and the like).

In some embodiments of the invention can include one or more features designed to minimizing rebound energy after impact, which could damage the cargo, e.g., by causing it to rotate on its side. The invention described herein can include one or more features designed to minimizing rebound energy after impact, which could damage the cargo, e.g., by causing it to rotate on its side. In some embodiment, the energy absorbing layers can include one or more frangible members that break upon impact to dissipate energy. In some cases, the composition can mitigate the overall weight of the energy absorbing layers (e.g., compared to conventional layers), can increase energy transfer through the layer, can facilitate the maintaining of the structural integrity of the layer (e.g., thereby allowing for multiple uses), and can be weather-resistant.

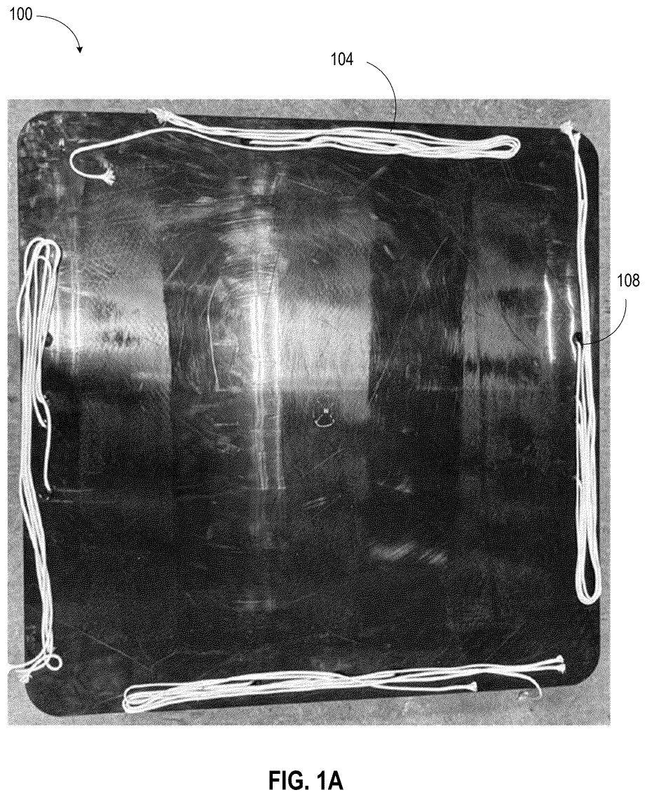

FIGS. 1A-1C are illustrative representations of a reusable universal skid board 100, according to some embodiments. The reusable universal skid board 100 can have dimensions of, for example, 48 inches in length, 48 inches in width, and 1 inch in height. Other exemplary dimensions include 42″ by 24″, and ¾″ in height. In some cases, the reusable universal skid board 100 can be used with energy absorbing layers in a variety of shapes and/or sizes such as, for example, 36″ by 36″, 36″ by 42″, 42″ by 42″, or 24 by 42, and/or the like. The reusable universal skid board 100 can be any size, shape, and/or dimension based on United States Air Force guidelines. The reusable universal skid board 100 can also be replicated and/or distributed based on United States Air Force guidelines. In some implementations, the reusable universal skid board 100 can also have apertures 108 which can also be pre-drilled. The reusable universal skid board 100 can have smooth sides, edges, and/or corners. As shown in FIG. 1A, the reusable universal skid board 100 can include cords 104 (e.g., netting) to be wrapped around items placed on top of the reusable universal skid board 100 (or on top of energy dissipation pods (not shown in FIG. 1A)). The cords 104 can pass through the apertures 108 located at each side of the reusable universal skid board 100.

In some implementations, the reusable universal skid board 100 can include a rigid body comprised of polymeric material. The body of the reusable universal skid board 100 can define a flat upper surface and one or more apertures 108 such that one or more cords 104 are couplable to the one or more apertures 108. The rigid body can further define a bottom surface coupled to the top surface and defining an internal volume such as, for example, air, foam, etc. In some implementations, the apertures 108 can be through-holes extending from the flat upper surface to the bottom surface of the rigid body of the reusable universal skid board 100 and can have cylindrical walls extending through and sealing the internal volume. The rigid body can include rounded corners and edges as shown in FIG. 1C. In some implementations, the rigid body can also have sufficient buoyance such that the rigid body can float in water without load. In some implementations, the reusable universal skid board 100 can include one or more removable plugs (not shown in FIGS. 1A-1C) to allow for water to enter the internal volume to modify buoyance. In some cases, the removable plugs can be dissolvable in water and/or seawater.

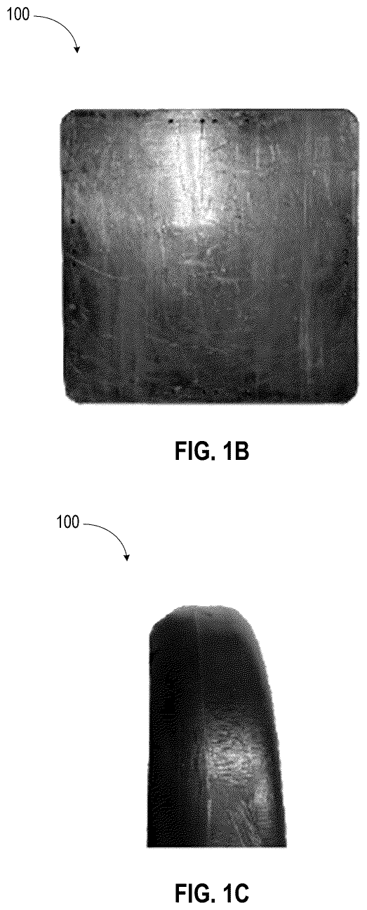

FIG. 2 is an illustrative representation of a apertures at the side of the reusable universal skid 100 board of FIG. 1, according to some embodiments. The reusable universal skid board 100 can include, for example, a set of four apertures 108. In some cases, the apertures 108 can be used as tie-down points for various types of cords, nettings, and/or the like. In some implementations, the universal skid board 100 can also include and/or be coupled with hands 204 that can allow for improved handling of the reusable universal skid board 100.

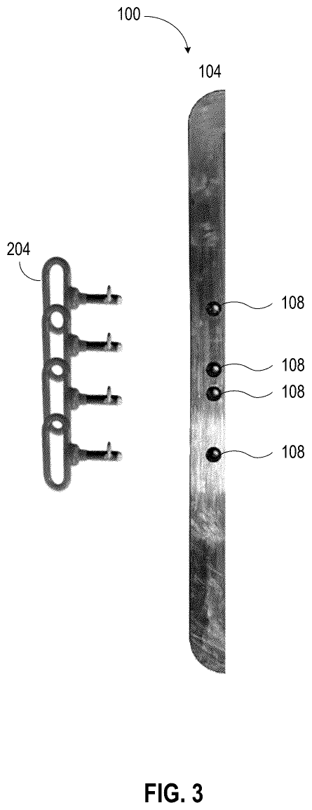

FIG. 3 is an illustrative representation of a reusable universal skid board 100 of FIG. 1 with an assembly of energy absorbing layers 304 placed on top of the reusable universal skid board 100, according to some embodiments. In some implementations, the assembly of energy absorbing layers can be secured and/or surrounded by a wrap 300 that can include, for example, a belt used to surround and/or secure energy absorbing layers 304 such that the energy absorbing layers 304 do not easily separate from each other or the reusable universal skid board 100.

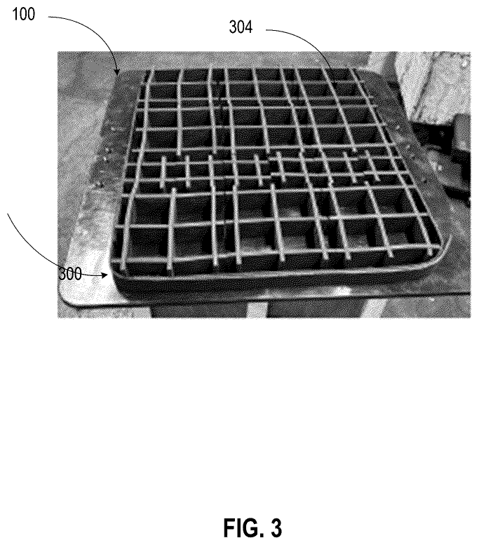

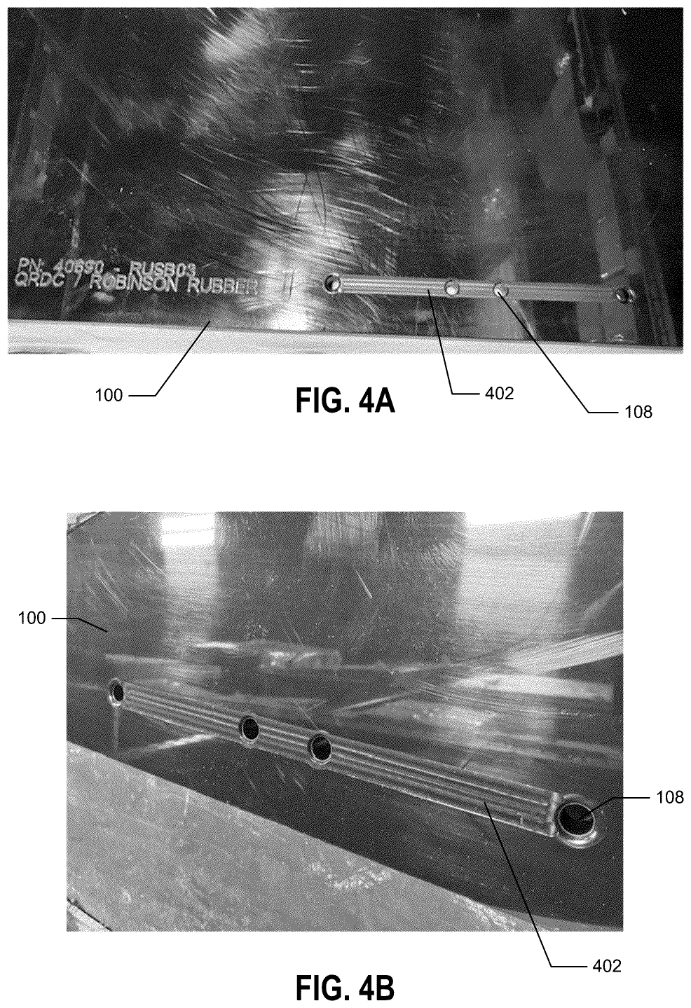

FIG. 4A shows an example of a skid board 100 that has grooves 402 between a plurality of apertures 108. FIG. 4B shows a closer view of the skid board 100, grooves 402, and apertures 108. The apertures 108 may allow for rope, cables, straps, etc., to be threaded through the skid board 100 in order to tie down or otherwise secure a load to the skid board. The rope (etc.) may lie within the grooves 402, which may reduce or prevent connected ropes from rubbing, fraying, and/or jamming against external objects, such as rollers.

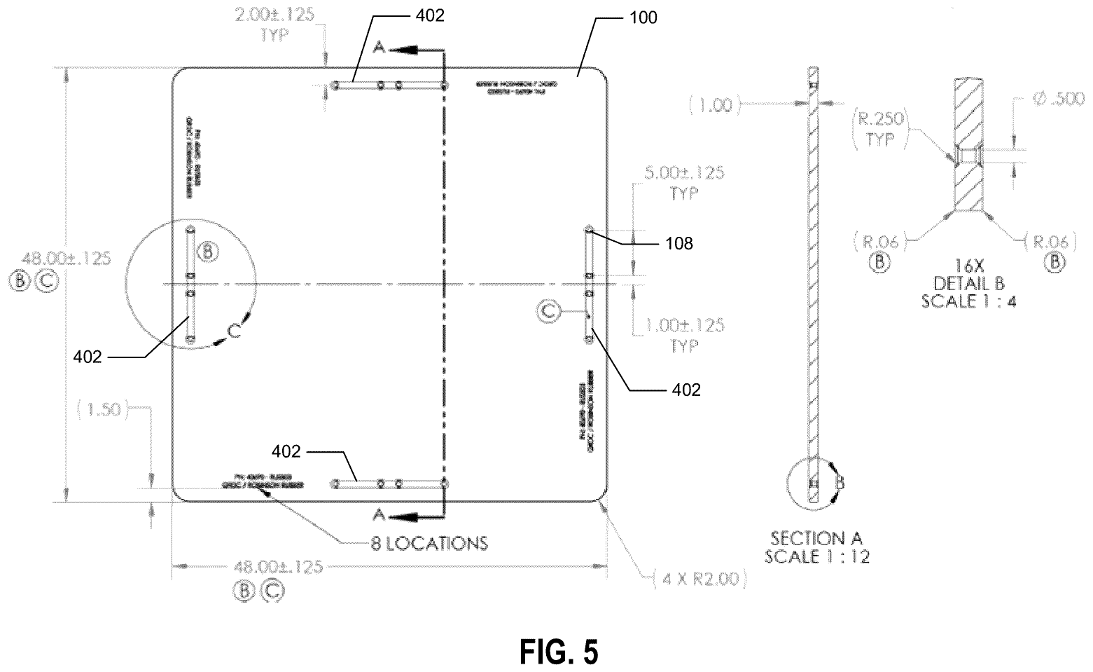

FIG. 5 shows an engineering drawing of an example of a skid board 100, which has 4 grooves 402, and 4 sets of apertures 108 (not all labeled).

All combinations of the foregoing concepts and additional concepts discussed herewithin (provided such concepts are not mutually inconsistent) are contemplated as being part of the subject matter disclosed herein. The terminology explicitly employed herein that also can appear in any disclosure incorporated by reference should be accorded a meaning most consistent with the particular concepts disclosed herein.

The drawings are primarily for illustrative purposes, and are not intended to limit the scope of the subject matter described herein. The drawings are not necessarily to scale; in some instances, various aspects of the subject matter disclosed herein can be shown exaggerated or enlarged in the drawings to facilitate an understanding of different features. In the drawings, like reference characters generally refer to like features (e.g., functionally similar and/or structurally similar elements).

The entirety of this application (including the Cover Page, Title, Headings, Background, Summary, Brief Description of the Drawings, Detailed Description, Embodiments, Abstract, Figures, Appendices, and otherwise) shows, by way of illustration, various embodiments in which the embodiments can be practiced. The advantages and features of the application are of a representative sample of embodiments only, and are not exhaustive and/or exclusive. Rather, they are presented to assist in understanding and teach the embodiments, and are not representative of all embodiments. As such, certain aspects of the disclosure have not been discussed herein. That alternate embodiments cannot have been presented for a specific portion of the innovations or that further undescribed alternate embodiments can be available for a portion is not to be considered to exclude such alternate embodiments from the scope of the disclosure. It will be appreciated that many of those undescribed embodiments incorporate the same principles of the innovations and others are equivalent. Thus, it is to be understood that other embodiments can be utilized and functional, logical, operational, organizational, structural and/or topological modifications can be made without departing from the scope and/or spirit of the disclosure. As such, all examples and/or embodiments are deemed to be non-limiting throughout this disclosure.

Also, no inference should be drawn regarding those embodiments discussed herein relative to those not discussed herein other than it is as such for purposes of reducing space and repetition. For example, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

Various concepts can be embodied as one or more methods, of which at least one example has been provided. The acts performed as part of the method can be ordered in any suitable way. Accordingly, embodiments can be constructed in which acts are performed in an order different than illustrated, which can include performing some acts simultaneously, even though shown as sequential acts in illustrative embodiments. Put differently, it is to be understood that such features can not necessarily be limited to a particular order of execution, but rather, any number of threads, processes, services, servers, and/or the like that can execute serially, asynchronously, concurrently, in parallel, simultaneously, synchronously, and/or the like in a manner consistent with the disclosure. As such, some of these features can be mutually contradictory, in that they cannot be simultaneously present in a single embodiment. Similarly, some features are applicable to one aspect of the innovations, and inapplicable to others.

In addition, the disclosure can include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein can be implemented in a manner that enables a great deal of flexibility and customization as described herein.

All definitions, as defined and used herein, should be understood to control over dictionary definitions, definitions in documents incorporated by reference, and/or ordinary meanings of the defined terms.

The indefinite articles “a” and “an,” as used herein in the specification and in the embodiments, unless clearly indicated to the contrary, should be understood to mean “at least one.”

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Less specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

Unless specifically stated or obvious from context, the term “or,” as used herein, is understood to be inclusive.

The terms “proximal” and “distal” can refer to the position of a portion of a device relative to the remainder of the device or the opposing end as it appears in the drawing. The proximal end can be used to refer to the end manipulated by the user. The distal end can be used to refer to the end of the device that is inserted and advanced and is furthest away from the user. As will be appreciated by those skilled in the art, the use of proximal and distal could change in another context, e.g., the anatomical context in which proximal and distal use the patient as reference, or where the entry point is distal from the user.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 (as well as fractions thereof unless the context clearly dictates otherwise).

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A reusable skid board comprising:
a rigid polymeric body defining:
a flat upper surface;
one or more apertures at each side of the rigid polymeric body such that one or more cords are couplable to the one or more of aperture; and
a bottom surface coupled to the top surface and defining an internal volume,
wherein the rigid polymeric body includes rounded corners and edges and has sufficient buoyancy such that the rigid polymeric body can float without load in seawater.

2. The reusable skid board of claim 1, wherein the internal volume contains air.

3. The reusable skid board of claim 1, further comprising one or more removable plugs, the removal of which allow water to enter the internal volume to modify buoyancy.

4. The reusable skid board of claim 3, wherein the removable plugs are dissolvable in seawater.

5. The reusable skid board of claim 1, wherein the internal volume contains foam.

6. The reusable skid board of claim 1, wherein the one or more apertures are through-holes extending from the flat upper surface to the bottom surface with a cylindrical wall extending through and sealing the internal volume.

7. The reusable skid board of claim 1, wherein the one or more apertures at each side includes two or more apertures at each side, and further comprising one or more grooves on each side, between the two or more apertures on each respective side.
